(19) United States
(12) Patent Application Publication
(10) Pub. No.: US 2002/0059685 A1
(43) Pub. Date: May 23, 2002

(54) Toothbrush and a toothbrush head therefor

(76) Inventor: Dieter Paffrath, Seefeld (DE)

Correspondence Address: ERIC L. PRAHL, Fish & Richardson P.C., 225 Franklin Street, Boston, MA, 02110-2804, US

(21) Appl. No.: 10/055,170

(22) Filed: Jan. 23, 2002

Related U.S. Application Data
(63) Continuation of application No. PCT/EP00/06673, filed on Jul. 13, 2000.

(30) Foreign Application Priority Data
Aug. 4, 1999 (DE) 19936637.3

(51) Int. Cl. A61C 15/00; A61C 17/22

(52) U.S. Cl. 15/28; 15/22.1; 132/321; 132/322; 132/329

(57) ABSTRACT

The invention is directed to a toothbrush and a toothbrush head therefor which is attachable to a handle of the toothbrush and adapted to be driven by a drive of the toothbrush. The toothbrush head possesses a carrier piece on which a spike is provided for interproximal cleaning, wherein according to the invention the spike is mounted for sliding motion in the direction of its longitudinal axis and is equipped with an overload protection device enabling the spike to retract when a predetermined load is applied.

This invention relates to a toothbrush with a preferably electric drive for driving a toothbrush head. Further, the invention relates to a toothbrush head therefor, having a carrier piece on which a spike for interproximal cleaning is provided.

The cleaning of interproximal spaces is becoming increasingly important in connection with dental cleaning and care. In order to penetrate hard-to-reach interproximal spaces to remove dental film and plaque it has already been proposed, for example in EP 0 765 642, to use specially shaped brush arrangements in which tufts of bristles are arranged at an inclination in opposition to the direction of rotation of the toothbrush head so as to be better able to penetrate the interproximal spaces. Provision has also been made already for special bristle tufts that project in length beyond the other bristles on the brush head, have a contour that tapers toward the working tip, and consist of stiffer bristles in order to be better able to penetrate the interproximal spaces.

However, bristle tufts of this type, which are provided to penetrate into interproximal spaces, are subjected in particular measure to mechanical loads and suffer faster wear in the course of time. They are inclined to bend over. With a view to cleaning between the teeth with a cleaning tool of enhanced stability attempts were made to replace the tufts in question with a plastic spike, which can be moved into interproximal spaces in order to remove food remnants, bacterial film, plaque and the like. However, cleaning teeth with such a spike tends to be subjectively experienced as unpleasant. Furthermore, with such a spike there is a risk of it injuring the gums when penetrating periodontal pockets.

It is therefore an object of the present invention to provide an improved toothbrush and an improved toothbrush head, which avoid the disadvantages of prior art devices, advancing the art in advantageous manner. In particular it is intended to provide for an improved cleaning of the interproximal spaces that is perceived as pleasant and harbors no risks of injury.

According to the present invention the object identified with regard to the toothbrush head is accomplished by a toothbrush head in accordance with patent claim 1. The object of the invention as regards the toothbrush is accomplished by a toothbrush in accordance with patent claim 11. Preferred embodiments of the invention are the subject of the sub-claims.

The spike or a comparable device for interproximal cleaning is mounted for sliding motion in the direction of its longitudinal axis and equipped with an overload protection device or some other provision that permits the spike to retract under a predetermined load. When excessive pressure is applied, for example when the user tries to force the spike into an interproximal space that is too narrow, the spike will recede. The overload protection device maintains the spike in its extended position only up to a certain load. Hence the cleaning operation is experienced as gentle and pleasant in spite of the preferably wear-proof spike. Risk of injury by the spike is prevented or significantly reduced.

In a further aspect of the invention the overload protection device is constructed to be reversible. Provision is made for an automatic, in particular elastic resetting of the spike after the overload protection device responded to an excessive load and the spike was retracted. When the load drops below the predetermined value the spike is extended again, so that with load cycles along these lines the spike automatically travels back and forth.

Provision can be made in advantageous manner for a spring arrangement that biases the spike to its extended position. In a further aspect of this invention provision is made for a spiral spring bearing against the spike, said spiral spring being positioned preferably inside the spike.

It is also possible for the spike to be constructed as compressible in itself, i.e., the spike has a compression element that forms an integral part of the spike body. In particular the spike can be constructed such that, when the predetermined pressure load is reached, the spike body undergoes a cross-sectional deformation, changing its length in the process. The compression element, which can be constructed as a hollow wall section, bulges in radial direction, thus shortening the length of the spike. Conveniently, the compression element is constructed to be elastic, thus resulting in the spike traveling back and forth in accordance with the pressure load acting on it.

For the spike to be able to penetrate into the interproximal spaces easily and deeply it preferably has a conically tapering tip whose end can be rounded off and/or flattened in order to prevent injuries to the oral cavity. The spike suitably has a circular cross section. The angle of taper at which the tip tapers can vary by choice and is adapted to the interproximal spaces. It can be chosen to lie between 15 and 30 degrees and is preferably about 22 degrees.

The thickness of the spike at the base of the conically tapering tip can be considerably greater than that of conventional bristles. It can amount to a multiple of the diameter of conventional bristles. The length of the spike can vary by choice. It is as small as possible but sufficient to be able to penetrate the interproximal spaces to the desired depth.

In a further aspect of the invention provided for the thorough cleaning of the interproximal spaces, the spike automatically adapts to the various contours of the interproximal spaces so that it rests snugly against the respective tooth surface and cleans it completely. For this purpose the spike is constructed to be elastically deformable in its cross section. At least its surface may be made of an elastic plastic or rubber material.

For the thorough removal of harder dental film, plaque and the like the spike displays a suitable surface roughness. The spike can be roughened for this purpose. In a further aspect of the invention provision can be made for a set of bristles on the surface of the spike. In particular the bristles can be arranged on the radial circumferential surface of the conically tapering tip of the spike. Particularly when the forward end of the spike is flattened or rounded off this end can also be equipped with bristles which project forwardly parallel to the longitudinal axis of the spike. The set of bristles effects an efficient removal of food remnants, dental plaque and the like.

Conveniently, the spike is arranged in a direction substantially coaxial with the motion axis of the toothbrush head. The spike is driven to rotate by the drive of the toothbrush. In particular it can be non-rotatably anchored to the carrier piece of the toothbrush head so that it rotates therewith. Through its rotary movement the spike removes even stubborn debris, plaque and the like from within the interproximal spaces.

As an addition or alternative to the rotation, the spike can be driven to oscillate in its longitudinal direction. On the one hand such a movement makes it easy to penetrate the interproximal spaces. On the other hand it provides an additional cleaning movement.

In a further aspect of the invention provision is made on the toothbrush head for further cleaning tools in addition to the spike already described. In particular a multiplicity of bristles, preferably in the form of several tufts, are affixed to the carrier piece. The tufts see to the cleaning of the tooth surfaces adjacent to the interproximal spaces. Preferably they are arranged concentrically around the spike so that they process the adjacent tooth flanks when the spike penetrates an interproximal space. For the interproximal cleaning to be more effective, the tufts are shorter than the spike or the spike projects beyond the working ends of the tufts.

The present invention will be explained in more detail in the following with reference to preferred embodiments and the associated drawings. In the drawings,

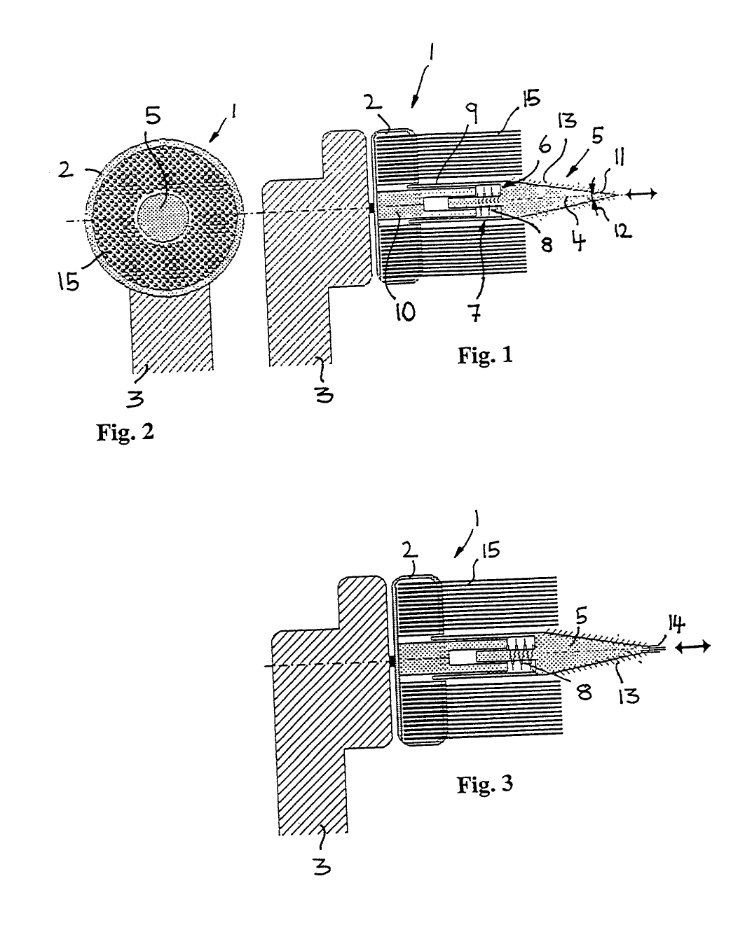

FIG. 1 is a schematic sectional view of a toothbrush head of a toothbrush in accordance with a preferred embodiment of the invention, having a retractable and extendible central spike for interproximal cleaning;

FIG. 2 is a plan view of the toothbrush head of FIG. 1;

FIG. 3 is a schematic sectional view of a toothbrush head similar to FIG. 1 in accordance with a further preferred embodiment of the invention, in which the tip of the spike is flattened off and equipped with forwardly protecting bristles;

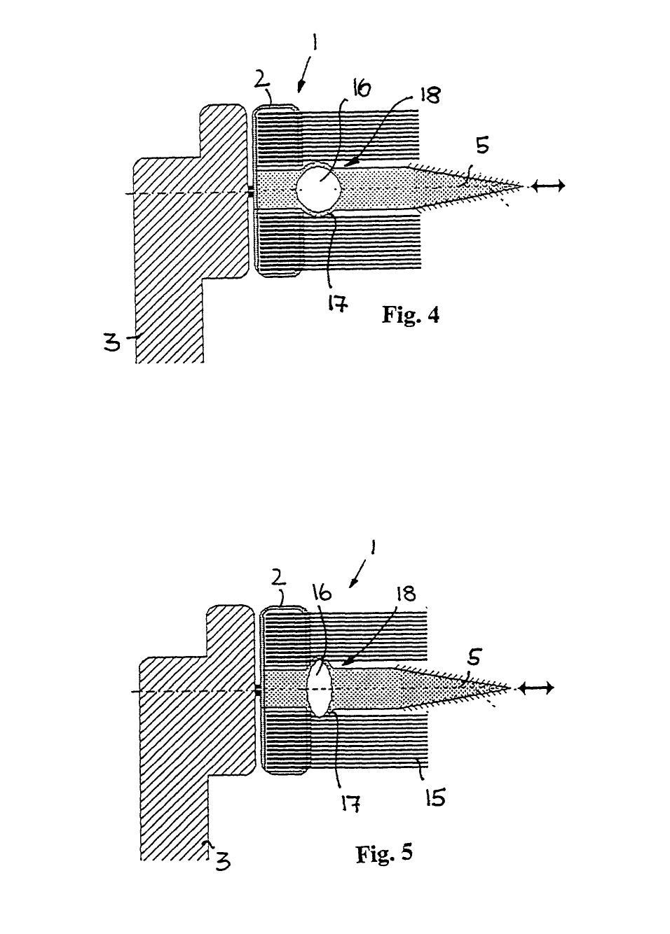

FIG. 4 is a schematic sectional view of a toothbrush head in accordance with a further preferred embodiment of the invention similar to FIG. 1, the spike being shown to have a hollow section with an elastically compressible wall;

FIG. 5 is a schematic sectional view of the toothbrush head of FIG. 4, the spike being shown in the compressed, shortened state;

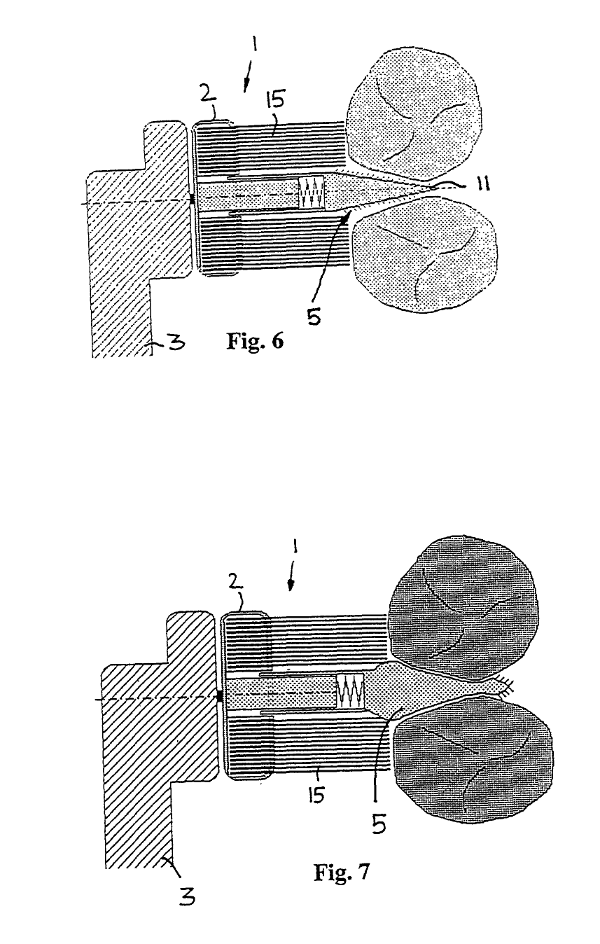

FIG. 6 is a schematic sectional view of a toothbrush head in accordance with a further preferred embodiment of the invention, the spike being shown inserted in an interproximal space to perform interproximal cleaning;

FIG. 7 is a schematic sectional view similar to FIG. 6, showing the elastic deformability of the spike in its cross section and the spike's adaptation to, or snug engagement with, the dental surfaces in the interproximal space; and

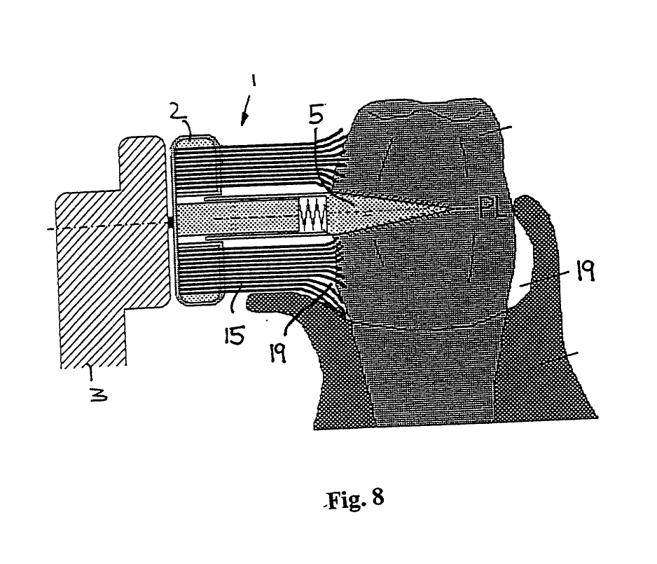

FIG. 8 is a schematic sectional view of a toothbrush head having its spike inserted in an interproximal space to perform interproximal cleaning, illustrating the cleaning of periodontal pockets by means of bristle tufts surrounding the spike.

The toothbrush head 1 of FIG. 1 is comprised of a circular, plate-shaped carrier piece 2 attachable to a handle 3, illustrated only schematically, of an electric toothbrush. The carrier piece 2 is mounted for rotation relative to the handle 3 about a motion axis 4. The carrier piece 2 can be driven to rotate in oscillating fashion in a manner known in the art by means of a drive, not shown, received in the handle 3 and preferably including an electric motor. In addition and in a manner equally known in the art, the drive may effect an oscillating translatory poking movement of the carrier piece 2 along the motion axis 4 in order to achieve better penetration into interproximal spaces.

Centrally mounted on the carrier piece 2 is a spike 5 whose longitudinal axis extends coaxially with the motion axis 4 of the carrier piece 2. It would also be possible for the spike to be arranged with its longitudinal axis in a slightly offset position relative to the motion axis 4 in order to produce an oscillating crosswise movement. The possibility would also exist for the spike 5 to be inclined at a slight angle to the motion axis 4. Preferably, however, it is aligned coaxially with the motion axis 4 of the carrier piece 2 as shown in FIG. 1.

Provided between the spike 5 and the carrier piece 2 is a sliding guide 6 that enables a limited translatory motion of the spike 5 parallel to the motion axis 4. As FIG. 1 shows, the sliding guide 6 is constructed as a telescope or the spike 5 is telescopable. A guide pin 7 projecting from the carrier piece 2 and a sleeve section formed at the base of the spike 5 are in telescoping relation with each other, enabling the spike 5 to move relative to the carrier piece 2 along the motion axis 4. The sliding guide 6 is non-rotatably constructed, meaning that the spike 5 rotates together with the carrier piece 2 about the motion axis 4 and co-performs its oscillating rotating movement.

The spike 5 is pushed into its extended position, i.e. away from the carrier piece 2, by means of a spring arrangement 7. The spring arrangement 7 is mounted in the interior of the spike 5 and is integrated in the sliding guide 6. A spiral spring sits at the bottom of the sleeve section 9 and bears against the end of the guide pin 10 (cf. FIG. 1). By means of the spiral spring 8 it is possible to precisely adjust the compressive force at which the spike 5 gives way, and it is also possible for the spike 5 to achieve a relatively long travel.

The spike 5 is made of an elastic plastic or rubber material so that it is on the whole elastic.

The spike is of a tapering configuration from its base on the carrier piece 2 to its end remote from the carrier piece. It has a conically tapering tip 11 with a circular cross section. The angle of taper 12 lies between 20 and 25 degrees, particularly 22 degrees, approximately.

To accomplish a more thorough removal of plaque, dental film or food remnants from the interproximal spaces the spike 5 has a set of bristles on its working faces. A multiplicity of bristles 13 projects radially from the flanks of the tip 11. Additionally or alternatively to the radially projecting bristles it is possible to provide tip bristles 14 on the spike 5 (cf. FIG. 3). In this case the tip 11 is preferably flattened off. The tip bristles 14 project forwardly in longitudinal direction, i.e., they extend from the forward end of the spike 5 parallel to the spike longitudinal axis. Otherwise the embodiment of FIG. 3 is the same as that illustrated in FIGS. 1 and 2, so that no further explanation is necessary.

As FIGS. 1 and 2 show, the toothbrush head 1 not only has the central spike 5 but also a multiplicity of bristles that can be arranged in tufts. The bristles 15 are attached to the carrier piece 2 in a concentric array around the spike 5. They project from said carrier piece parallel to the motion axis 4. However, they could also be arranged at an incline, preferably inclined inwardly toward the spike 5. Provision could also be made for the bristles 15 to be inclined outwardly away from the spike 5 in order to produce a corresponding cleaning effect. The free ends, meaning the working ends of the bristles 15, lie in a plane perpendicular to the motion axis 4 (cf. FIG. 1). To permit better penetration into the interproximal spaces the working ends of the bristles 15 could also be provided in steps, with the bristle length decreasing in outward direction so that the bristles 15 define a convex, pyramidal working plane. To produce an enhanced cleaning effect at the outer edges, particularly in periodontal pockets, the bristles 15 could also define a convex working plane, with the outer lying bristles being longer than those bristles 15 arranged closer to the spike 5.

As FIG. 1 shows, the spike 5 has a diameter substantially greater than the thickness of the bristles 15. At its base the spike 5 has a diameter equal to between one sixth and one half of the diameter of the carrier piece 2, in particular approximately one quarter of the diameter of the carrier piece 2. The length of the spike 5 is likewise significantly longer than the length of the bristles 15. As FIG. 1 shows, the tip of the spike 5 projects by about two thirds of the free-carrying length of the bristles 15 beyond the working ends of said bristles.

An alternative embodiment of the toothbrush head 1 shown in FIGS. 1 to 3 is illustrated in FIG. 4 which is notable for its particular simplicity. Instead of the spring arrangement incorporating the spiral spring 8, the spike 5 is itself constructed to be resilient in its longitudinal direction. In the area of the base of the spike 5 provision is made for a cavity 16 around which the spike 5 has a bulged wall 17 of elastic construction. When a corresponding compressive force is applied to the tip 11 of the spike 5, the wail 17 bulges in radial direction and forms an ellipse, as shown in FIG. 5. In other words, the spike 5 is compressed and reduced in length. The elastic compression element, which is formed by the cavity 16 and its wall 17, is integrally formed with the spike 5. The spike is integrally made of one piece on the whole. The multiple-member telescoping arrangement according to the embodiment of FIG. 1 can be dispensed with. A particularly simple and economical design of the spike 5 is thus achieved.

The function and the mode of operation of a toothbrush head according to the invention will be explained in more detail in the following with reference to FIGS. 6 to 8.

As FIG. 6 shows, the toothbrush head 1 with its spike 5 can be precisely inserted in an interproximal space. The projection of the tip 11 of the spike beyond the working ends of the bristles 15 surrounding the spike 5 is calculated so that the working ends of the bristles 15 are positioned against the tooth flanks adjacent to the respective interproximal space when the spike 5 is fully inserted in the interproximal space. The bristles 15 are thus able to clean the tooth surfaces adjacent to the interproximal space. During this operation the toothbrush head 1 experiences an oscillating rotary movement about its motion axis 4, which, where provided, can be accompanied by a poking movement along the motion axis. The spike 5 is coupled to the movement in question.

The elastic yieldability of the spike 5 in the direction of its longitudinal axis prevents the spike 5 from being inserted with too much force in the interproximal spaces. Once the tip 11 has come to rest with its flanks against the tooth surfaces in the interproximal space, the spike 5 will retract, in telescoping fashion, against the biasing force of the spring if the toothbrush is pressed any further, meaning with greater force, against the teeth. Injuries are avoided as the result. The required contact force of the spike 5 adjusts itself automatically.

As FIG. 7 shows, the spike 5 is of a rubber-like elastic construction. It is deformable in its cross section and elastically yielding so that it adapts to the contour of the tooth surface in the interproximal space to be cleaned. The flanks of the spike 5 are in intimate engaging relationship with the opposite tooth surfaces. A thorough cleaning operation can thus be accomplished. Overstraining of the teeth is prevented, and the cleaning operation is experienced as gentle and pleasant.

By means of the bristles 15 surrounding the spike 5 it is possible in particular to efficiently clean bacterial film, food remnants and the like out of periodontal pockets. FIG. 8 shows that, when the spike 5 is inserted in an interproximal space, the bristles 15 surrounding the spike 5 push their way between the gums and the corresponding tooth. The gums are slightly raised in the process, enabling the bristles 15 to penetrate into the respective periodontal pocket 19. The bristles 15 can easily bend over against the surface of the corresponding tooth. In this way they penetrate to the bottom of the periodontal pocket (cf. FIG. 8). It is possible, particularly as a result of the yieldability of the spike 5 in its longitudinal direction, for the toothbrush head 1 to be pressed accordingly against the tooth to enable the bristles to perform this additional cleaning function.

1. A toothbrush head for a toothbrush handle (3) comprising a drive, said toothbrush head including a carrier piece (2), said carrier piece (2) having arranged on its a spike (5) and several bristles (15) or bristle tufts, and said spike (5) being mounted for sliding motion in the direction of its longitudinal axis relative to said carrier piece (2), wherein the spike (5) is biased into an extended position under the action of a biasing force and is caused to occupy a retracted position as a result of the force applied during the tooth cleaning operation.

2. The toothbrush head according to claim 1, wherein the spike (5) is extended again when the applied force is reduced.

3. The toothbrush head according to any one of the preceding claims, wherein provision is made for a spring arrangement (7) for producing the bias of the spike (5).

4. The toothbrush head according to any one of the preceding claims, wherein the spike (5) includes a compression element (18) integrally formed thereon, said compression element being preferably of an elastic configuration.

5. The toothbrush head according to any one of the preceding claims, wherein the spike (5) has a conically tapering tip (11), in particular with a circular cross section.

6. The toothbrush head according to any one of the preceding claims, wherein the spike (5) is constructed to be elastically deformable particularly in its cross section, being preferably made of an elastic plastic and/or rubber material.

7. The toothbrush head according to any one of the preceding claims, wherein the spike (5) is set with bristles (13), preferably with radially projecting bristles and/or bristles attached to the spike's forward end.

8. The toothbrush head according to any one of the preceding claims, wherein the spike (5) is arranged in a direction coaxial with the motion axis (4) of the toothbrush head.

9. The toothbrush head according to any one of the preceding claims, wherein the spike (5) is adapted to be driven to rotate by the drive of the toothbrush, being preferably connected with the carrier piece (2) in a non-rotating relationship.

10. The toothbrush head according to any one of the preceding claims, wherein a multiplicity of bristles (15), in particular several bristle tufts, are affixed to the carrier piece (2) adjacent to the spike (5), being preferably arranged around the spike in a concentric and/or eccentric array.

11. A toothbrush with a handle (3) including a drive, in combination with a toothbrush head (1) according to any one of the preceding claims.
